(19) United States
(12) Patent Application Publication
(10) Pub. No.: US 2026/0103360 A1
(43) Pub. Date: Apr. 16, 2026

(54) SAFETY TORQUE OFF DEVICE FOR INTERRUPTING THE GENERATION OF TORQUE BY AN ELEVATOR INSTALLATION DRIVE MACHINE SUPPLIED BY A POWER SUPPLY DEVICE

(71) Applicant: INVENTIO AG, Hergiswil (CH)

(72) Inventors: Adrian Schaller, Luzern (CH); Thomas Eilinger, Kussnacht a/Rigi (CH)

(21) Appl. No.: 19/421,794

(22) Filed: Dec. 16, 2025

Related U.S. Application Data
(63) Continuation of application No. 17/593,854.

(30) Foreign Application Priority Data
Mar. 29, 2019 (EP) 19166306.1

(51) Int. Cl. B66B 1/30; B66B 5/02; B66B 11/04; H02P 3/18

(52) U.S. Cl. CPC B66B 1/308; B66B 5/02; B66B 11/043; H02P 3/18

(57) ABSTRACT

A safety torque off (STO) device interrupts torque generation by an elevator installation drive machine supplied by a power supply device being part of an inverter device, for example. The STO device includes a control input, signal input terminals connected to signal generation device outputs and signal output terminals connected to driver circuit inputs. Each of the STO signal input terminals is electrically connected to an associated one of the signal generation device outputs via first and second signal transmission switches connected in series. The control input is connected to first and second control units, wherein the first control unit, controlled by a control signal applied to the control input, switches switching states of all the first signal transmission switches and the second control unit, controlled by a control signal applied to the control input, switches switching states of all of the second signal transmission switches.

### CROSS-REFERENCE TO RELATED APPLICATIONS

This application is a continuation of the co-pending U.S. patent application Ser. No. 17/593,854 filed Mar. 29, 2020.

### FIELD

The present invention relates to a safety torque off device for interrupting the generation of torque by an elevator installation drive machine supplied by a power supply device. The invention also relates to an inverter device for providing electrical drive power for a drive machine of an elevator installation and an elevator installation equipped therewith.

### BACKGROUND

In an elevator installation, an elevator car is typically displaced vertically with the aid of a drive machine between different height levels to stop positions on different floors where passengers should be able to get in and out of the elevator car. In order not to endanger the passengers, it must be ensured that the elevator car is not shifted any further while a passenger is getting on or off.

In order to be able to ensure this, regulations such as the European standard EN81-20:2014 may require that suitable technical measures be used to ensure that torque generation by the drive machine can reliably temporarily be prevented, for example in response to a predetermined signal from a safety chain of the elevator installation. It may be required here that the technical measures to be used must result in the drive machine not being able to be supplied with electrical drive power during a period in which the predetermined signal is output. Technical devices that can be used to reliably interrupt a torque generation by a drive machine are also referred to as safety torque off devices or STO.

CN 104355195 describes a safety torque off device and an elevator safety control system. In response to a control signal, a power supply to a power unit that supplies a drive machine is temporarily interrupted.

Among other things, there may be a need for a safety torque off device with the aid of which torque generation by a drive machine of an elevator installation supplied by a power supply device can be reliably and temporarily interrupted and which is simple and inexpensive to set up, install and/or maintain. Furthermore, there may be a need for an inverter device with the aid of which electrical drive power can be provided for a drive machine of an elevator installation and the provision of the drive power can be temporarily interrupted in a targeted, reliable and/or simple manner. Furthermore, there may be a need for an elevator installation having such an inverter device.

### SUMMARY

Such a need can be met by the subject matter of the advantageous embodiments in the following description.

According to a first aspect of the invention, a safety torque off device is proposed for interrupting torque generation by a drive machine of an elevator installation, which drive machine is supplied by a power supply device. The power supply device has a power input, a power output, a plurality of power switches connected to the power input and the power output, and a driver circuit that controls the power switches. The power supply device is configured in such a way that electrical power present at the power input is at least partially passed on to the power output in a controlled manner by the power switches and the power switches are controlled on by the driver circuit as a function of signals sent by a signal generator device via a first plurality of signal outputs to signal inputs of the driver circuit. The safety torque off device has a control input and a second plurality of signal input terminals and signal output terminals. Each of the signal outputs of the signal generator device can be connected to one of the signal input terminals and each of the signal inputs of the driver circuit can be connected to one of the signal output terminals. Each of the signal input terminals can be electrically connected via a first and a second signal transmission switch connected in series to an associated one of the signal output terminals by switching both the first signal transmission switch and the second signal transmission switch to a conductive switching state. The control input is electrically connected to a first and a second control unit, wherein the first control unit switches switching states of all of the first signal transmission switches in a manner controlled by a control signal present at the control input and the second control unit switches switching states of all of the second signal transmission switches in a manner controlled by the control signal present at the control input.

According to a second aspect of the invention, an inverter device for providing electrical drive power for a drive machine of an elevator installation is described. The inverter device has a signal generator device, a power supply device and a safety torque off device according to an embodiment of the first aspect of the invention. The signal generator device is configured to generate control signals, wherein the signal generator device comprises a first plurality of signal outputs. The power supply device is equipped with a power input, a power output, a plurality of power switches connected to the power input and the power output, and a driver circuit that controls the power switches. The power supply device is configured in such a way that electrical power present at the power input is at least partially passed on to the power output in a controlled manner by the power switches and the power switches are controlled on by the driver circuit as a function of signals sent by a signal generator device via a first plurality of signal outputs to signal inputs of the driver circuit. It should apply to the safety torque off device that each of the signal outputs of the signal generator device is connected to one of the signal input terminals and each of the signal inputs of the driver circuit is connected to one of the signal output terminals.

According to a third aspect of the invention, an elevator installation is described which comprises an inverter device according to an embodiment of the second aspect of the invention, a main power source for providing electrical power to the power input of the power supply device of the inverter device, and an electric drive machine which is connected to the power output of the power supply device.

Possible features and advantages of embodiments of the invention can be considered, among others and without limiting the invention, to be based upon the concepts and findings described below.

As already stated in the introduction, prior art CN 104355195 discloses a safety torque off device for an elevator installation, with the aid of which a power supply to a power unit that supplies the drive machine of the elevator installation can be temporarily interrupted. However, in this known approach, the power supply to the drive machine is interrupted by direct intervention in the power supply of the power unit, for example an inverter device, with the aid of which an electrical current provided by a main power source is supplied to the drive machine in a regulated manner. To interrupt the power supply, appropriate hardware must be provided directly on the power unit. This hardware must therefore meet the high safety requirements applicable to the power unit. In addition, this hardware must be able to cope with the high electrical power to be regulated by the power supply and be able to reliably interrupt it temporarily if necessary.

In contrast to the approach described above, the safety torque off device described here serves to cause the power supply device, for example an inverter device, to temporarily not pass on any electrical power to a drive machine connected to it, although the power supply device itself can be continuously supplied with electrical power from a main power source.

For this purpose, the safety torque off device is configured to interact with a driver circuit which controls power switches in the power supply device. The driver circuit can be part of an inverter which, in addition to the driver circuit, can include the power supply device to be controlled by it with the power switches and, if necessary, further electronics. Such a driver circuit generally serves to control the function of the power switches in the power supply device as a function of signals applied to the driver circuit. The signals are generally generated by a signal generator device such as a digital signal processor (DSP) in an inverter control and applied to signal inputs of the driver circuit. As a function of these signals, the driver circuit can then suitably control power switches such as, for example, a plurality of IGBTs (insulated-gate bipolar transistor) in the power supply device in order to induce them to adjust to at least pass on a portion of the electrical power made available by the main power source to the drive machine of the elevator installation.

The safety torque off device proposed herein is connected between the signal generator device and the driver circuit of the power supply device. The safety torque off device serves to forward the signals generated by the signal generator device to the driver circuit. However, the safety torque off device is additionally configured to be able to temporarily and reliably interrupt a forwarding of signals generated by the signal generator device to the driver circuit in a controllable manner.

For this purpose, the safety torque off device has at least one control input and a plurality of signal input terminals and signal output terminals, referred to herein as a second plurality.

The second plurality is the same size or greater than the first plurality of signal outputs of the signal generator device. In other words, the safety torque off device has at least as many signal input terminals and signal output terminals as there are signal outputs on the signal generator device. Accordingly, each of the signal outputs of the signal generator device can be connected to one of the signal input terminals. Furthermore, each of the signal inputs of the driver circuit can be connected to one of the signal output terminals of the safety torque off device.

Typically, a signal generator device, which is designed for example with a digital signal processor, has at least six signal outputs in order to be able to control the three phases with two power switches each of a three-phase current used for power supply in the power supply device. Accordingly, the safety torque off device is to be equipped with six or more signal input terminals and six or more signal output terminals.

Signals generated by the signal generator device and present at the signal outputs of the signal generator device can thus be passed on from the signal input terminals of the safety torque off device connected to them to their signal output terminals. From there, the signals are sent to the signal inputs of the driver circuit. In response to the signals received, the driver circuit can in turn suitably control the power switches of the power supply device in order to provide electrical power at the power output of the power supply device for the elevator installation drive machine.

In order to be able to interrupt a signal transmission from the signal generator device through the safety torque off device to the driver circuit in a controlled and reliable manner, a first signal transmission switch and a second signal transmission switch are provided in the safety torque off device between each of the signal input terminals and the associated signal output terminal. These two signal transmission switches are connected to one another in series. Accordingly, when both signal transmission switches are switched to an electrically conductive switching state, an electrical connection can be established between the respective signal input terminal and the associated signal output terminal. If, however, at least one of these signal transmission switches is open, that is to say switched to a non-electrically conductive switching state, an electrical connection between the respective signal input terminal and the associated signal output terminal is interrupted.

In order to increase the reliability or safety with which the signal transmission through the safety torque off device can be interrupted in a controlled manner, i.e. to maximize a safety level of the safety torque off device, it is provided that the first signal transmission switch is controlled by a first control unit and the second signal transmission switch is controlled by a second control unit. Both control units are electrically connected to the control input of the safety torque off device and receive an applied control signal from this, according to which the switching states of the first and second signal transmission switches are then controlled. In this way, a high level of redundancy can be achieved in the safety torque off device and thus the safety with which the safety torque off device prevents the electrical transmission of signals from the signal generator device to the driver circuit is maximized, if necessary.

In the foregoing and in the following, electrically connected means that the connection is formed electrically, that is to say by means of an electrically conductive current path between the points to be connected. An electromagnetic connection, such as that produced by a transformer, is not an electrical connection for the purposes of this application.

In particular, the safety torque off device can be configured in such a way that its signal transmission switches are closed and thus signal transmission from the signal generator device to the driver circuit is only established when a corresponding signal is present at the control input of the safety torque off device. For example, such a signal can be an electrical voltage different from zero and thus represent a logical “1”. If no such signal is present at the control input, the first control unit should activate all of the first signal transmission switches connected to it to open and the second control unit should activate all of the second signal transmission switches connected to it to open. This interrupts the electrical connection between the signal input terminals and the signal output terminals.

Even in the event that one of the control units does not provide a correct control signal and/or one of the signal transmission switches does not open due to a defect, for example, the electrical connection between the associated signal input terminal and the signal output terminal is still interrupted, since the other control unit correctly opens the signal transmission switch one connected to it.

Since, in the safety torque off device proposed here, two signal transmission switches are connected in series in all electrical feed-throughs between one of the signal input terminals and an associated signal output terminal, and each of these signal transmission switches is controlled by a different control unit, it is ensured that each of the electrical feed-throughs is interrupted by opening signal transmission switches when there is no signal at the control input of the safety torque off device, which signal explicitly instructs the signal transmission switch to close.

In other words, the safety torque off device with its signal transmission switches and control units should be designed in such a way that in the absence of a signal which indicates that no interruption of the torque generation by the drive machine is currently to be effected, the transmission of signals from the signal generator device to the driver circuit is automatically interrupted and in this way, the power supply from the power supply device to the drive machine is cut off so that, with certainty, the drive machine cannot generate torque.

Since not only some but all of the electrical connections between the signal outputs of the signal generator device and the signal inputs of the driver circuit are interrupted with a high degree of certainty, it can also be ensured that there are no undesirable effects due to crosstalk. In particular, undesired crosstalk from signals on uninterrupted connections to interrupted connections, which could lead to undesired activation of the driver circuit, can be avoided. Crosstalk from those power switches in the power supply device which are activated by the driver circuit of signals via uninterrupted connections from the signal generator device to other power switches in the power supply device can be excluded, since the safety torque off device proposed here ensures that in the event of an interruption at least five connections are interrupted and thus a maximum of one of the power switches is still activated by the driver circuit. This is sufficient, since only one IGBT is activated if there is a remaining connection. In this case, the alternating current machine is subjected to the resulting DC voltage, which is not a problem.

The functionality of the safety torque off device described above can be structurally implemented in different ways.

According to a possible and advantageous embodiment of the invention, each of the signal transmission switches can be designed, for example, with a normally conductive semiconductor switch, which, in the absence of a control voltage at a gate terminal, creates an electrical connection between the signal input terminal assigned to the signal transmission switch and a ground potential, and when there is no control voltage the control voltage at the gate terminal interrupts the electrical connection between the signal input terminal assigned to the signal transmission switch and a ground potential. In this case, each of the control units can be configured to apply the control voltage to the gate terminals of all signal transmission switches assigned to the respective control unit as a function of the control signal applied to the control input.

In other words, the signal transmission switches of the safety torque off device can be designed as semiconductor switches, for example in the form of MOSFETs, which in their normal state are electrically conductive, i.e. are normally conductive semiconductor switches. Such semiconductor switches typically have three terminals, which are often referred to as drain, source and gate. A control voltage applied to the gate terminal can decide whether or not an electrically conductive connection is established between the drain terminal and the source terminal. In the case of such a semiconductor switch that acts electrically conductive in the normal state, there is an electrical connection between the drain terminal and the source terminal without applying a control voltage to the gate terminal, whereas such an electrical connection is interrupted when a control voltage is applied to the gate terminal.

Normally conducting semiconductor switches of this type can advantageously be used for the embodiment mentioned, for example by connecting their drain terminal to the signal input terminal of the safety torque off device and connecting their source terminal to a ground potential. As long as no control voltage is applied to the gate terminal and the semiconductor switch is therefore electrically conductive, any signal generated by the signal generator device and applied to the signal input terminal is inevitably diverted via the semiconductor switch to the ground potential and thus cannot reach the signal output terminal and the associated driver circuit. In fact, a normally conductive semiconductor switch interconnected in this way thus acts like a switch which is open in the normal state, i.e., a switch which is not electrically conductive. Only when the control voltage is applied to the gate terminal of the semiconductor switch is the electrical connection to the ground potential interrupted so that the signal from the signal generator device applied to the drain terminal can be passed on to the signal output terminal of the safety torque off device.

In order to ensure that even in the event of a malfunction of one of the semiconductor switches, a reliable interruption of a signal transmission through the safety torque off device is guaranteed, two normally conductive semiconductor switches connected in series are connected between each of the signal input terminals and the associated signal output terminal. Even if one of these semiconductor switches should not establish an electrical connection to the ground potential due to a defect despite the lack of a control signal, such an electrical connection will most likely be effected at least at the second semiconductor switch and thus, in the absence of a control signal, the derivation of the signal from the signal generator device to the ground potential is guaranteed.

By using the proposed semiconductor switch, which is conductive in the normal state, and the described interconnection of the same, it can be ensured that, in the absence of a control voltage, a transmission of signals generated by the signal generator device through the safety torque off device is reliably interrupted.

In order to ensure that the desired control signal is fed to all semiconductor switches, the first control unit is connected to the semiconductor switch, which serves as the first signal transmission switch, and delivers its control signal to its gate terminal, whereas the second control unit is independently connected to the other semiconductor switch, which serves as a second signal transmission switch, and supplies its control signal to its gate terminal. As a result, two mutually independent paths for controlling the two semiconductor switches connected in series can be established and thus a redundancy that increases safety can be brought about when controlling the semiconductor switches.

According to one specific embodiment, each of the control units can comprise an optocoupler which is configured to establish the electrical control voltage at the gate terminals of all signal transmission switches assigned to the respective control unit as a function of the control signal applied to the control input.

In other words, both the first control unit and the second control unit can each have an optocoupler. Such an optocoupler can have two components that communicate optically with one another. A first component can be controlled by the voltage applied to the control input of the safety torque off device, i.e. by the control signal and, depending on the control signal received, can cause the second component to generate the electrical control voltage with which the semiconductor switch is connected to its gate terminal is controlled.

A circuit in which the first component of the optocoupler is integrated is in this case advantageously galvanically decoupled from another circuit in which the second component of the optocoupler is accommodated. In this way it can be ensured, for example, that the control signal, which is intended to indicate whether torque generation by the drive machine is to be momentarily interrupted or not, cannot undesirably influence the signals generated by the signal generator device and possibly forwarded to the driver circuit of the inverter.

According to a further specific embodiment, the optocoupler can comprise a light source to be activated by the control signal applied to the control input and a photodiode unit that generates the control voltage through illumination by the light source.

In other words, the optocoupler can comprise a light source as the first component, for example in the form of an LED, which is activated and thus emits light when the control signal is applied to the control input of the safety torque off device and thus reaches the control unit containing the optocoupler. As a second component, the optocoupler can then comprise a photodiode unit which, when illuminated, generates an electrical voltage corresponding to the control voltage.

The light source and the photodiode unit can be positioned relative to one another and coordinated with one another in such a way that the light emitted by the light source when activated is received by the photodiode unit and stimulates it to generate the control voltage required to control the semiconductor switch.

According to a specific embodiment, the above-described photodiode unit can comprise two photodiodes connected in series.

Each of the photodiodes can preferably generate only part of the required control voltage. Only by connecting the two photodiodes in series can the entire control voltage required to control the semiconductor switches be generated. In this way, the safety of the entire circuit can be further increased, since the control voltage can only be generated by the optocoupler when the light source was activated in response to an applied control signal and then both photodiodes, due to the light received from the light source, generate their share of the control voltage for the semiconductor switches.

The safety torque off device can preferably be designed with hardware in accordance with a safety integrity level SIL3 and a hardware fault tolerance of at least 1.

In other words, the safety torque off device can be constructed with particularly safe hardware components and these hardware components can interact or be interconnected with one another in a particularly safe manner, so that the safety torque off device with a hardware fault tolerance of at least 1 meets the requirements of a safety integrity level SIL3, as defined in the IEC 61508 standard.

Implementation with such a reliably designed hardware can ensure that the safety torque off device can interrupt torque generation of the elevator installation drive machine with very high reliability and thus meet the very high safety requirements for the operation of an elevator installation.

The fulfillment of the safety integrity level SIL3 can be achieved, for example, with the hardware configurations described herein.

According to an advantageous embodiment, the safety torque off device can furthermore be designed without programmable components.

In other words, only so-called A components, such as transistors, but no B components, such as microprocessors, are used. This leads to better safety parameters, i.e. to a lower probability of failure and thus to a better classification. The so-called Safe Failure Fraction (SFF) is also reduced, which means that lower requirements for error detection must be met.

In other words, the safety torque off device can preferably be equipped or constructed exclusively with components which are not programmable and which therefore cannot change their functional or physical properties following an adaptable program.

By dispensing with programmable components, it can be ensured that the safety torque off device proposed here does not have to be newly certified for different versions of software with regard to safety qualifications to be complied with. Instead, the safety torque off device can be designed with its hardware in such a way that it can be used for purposes in power supply devices for drive machines in different elevator installations without having to be adapted for a particular purpose by means of special software. The hardware can be certified once for this purpose. Additional purpose-specific certifications can usually be dispensed with. In this way, maintenance expenditure in particular can be reduced.

Embodiments of the safety torque off device described herein can be used advantageously in particular in inverter devices according to the second aspect of the invention in order to be able to interrupt a signal transmission between a signal generator device and a power supply device in a controlled manner.

The signal generator device can be designed as a DSP, which can generate PWM signals (pulse-width-modulated signals) adapted to requirements and transmit them to the driver circuit for controlling the power supply device.

According to a specific embodiment, the power supply device can have an IGBT driver circuit and three upper and three lower IGBTs. The IGBTs can be activated by the IGBT driver circuit, as a function of control signals generated by the signal generator device and passed through the safety torque off device, to at least partially pass on electrical power present at the power input to the power output in a controlled manner.

In other words, a part serving as a power supply device, for example an inverter, can have two sets of IGBTs, with an upper set and a lower set each comprising three IGBTs. Each of the IGBTs is controlled by the driver circuit, wherein the driver circuit controls the IGBTs as a function of the control signals it receives from the signal generator device.

Embodiments of the safety torque off device described herein or the inverter device equipped therewith can be used in an elevator installation according to an embodiment of the third aspect of the invention in order to be able to ensure, if necessary, that the elevator installation drive machine temporarily cannot generate any torque and thus that the elevator car driven by the drive machine cannot be unintentionally moved. In this way, safety during the operation of the elevator installation can be increased.

For example, an operating state in the elevator installation can be monitored with the aid of a so-called safety chain. A plurality of door switches can be part of this safety chain, wherein the safety chain only is closed when all door switches are closed. A signal to be transmitted through the safety chain when the safety chain is closed can serve as a control signal to the control input of the safety torque off device. Accordingly, the control signal is only present at the control input when the safety chain is closed, i.e. when all door switches and the elevator doors connected to them are closed. Only in this case can the elevator installation drive machine be supplied with power. As soon as the safety chain is interrupted, the control signal at the control input of the safety torque off device is omitted, whereupon this reliably prevents the torque generation by the elevator installation drive machine. This ensures that the elevator car cannot be moved by the drive machine as long as at least one of the elevator doors is not completely closed.

It should be understood that some of the possible features and advantages of the invention are described herein with reference to different embodiments, on the one hand of the safety torque off device and on the other hand of the inverter device or the entire elevator installation equipped therewith. A person skilled in the art recognizes that the features can be combined, transferred, adapted, or exchanged in a suitable manner in order to arrive at further embodiments of the invention.

Embodiments of the invention will be described in the following with reference to the accompanying drawings, wherein neither the drawings nor the description are intended to be interpreted as limiting to the invention.

### DESCRIPTION OF THE DRAWINGS

FIG. 1 shows an elevator system according to an embodiment of the present invention.

FIG. 2 shows an inverter device according to an earlier concept.

FIG. 3 shows an inverter device according to an embodiment of the present invention.

FIG. 4 shows a circuit for a safety torque off device according to an embodiment of the present invention.

The drawings are merely schematic and not true to scale. Like reference signs refer to like or equivalent features in the various drawings.

### DETAILED DESCRIPTION

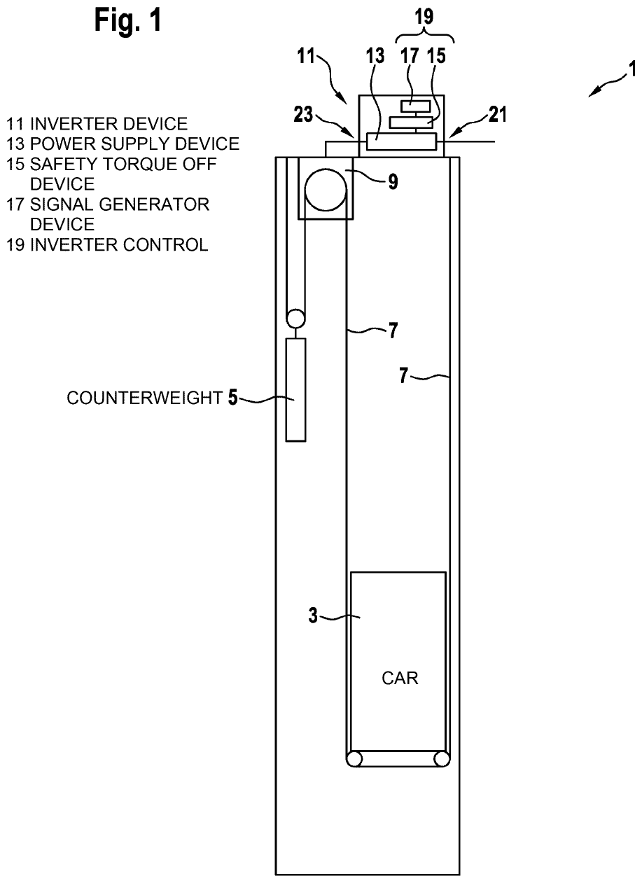

FIG. 1 shows an elevator installation 1 having an elevator car 3 and a counterweight 5, which can be displaced vertically by a drive machine 9 within an elevator shaft with the aid of a suspension element 7. The drive machine 9 is supplied with electrical power by an inverter device 11. The inverter device 11 comprises a power supply device 13 which is fed with electrical power from a main power source 71 (FIG. 3) at a power input 21 and which is controlled by a signal generator device 17 via signals.

If necessary, for example if the elevator car 3 stops on a floor and elevator doors are open to enable passengers to get on or off, it may be necessary to ensure that the elevator car 3 is not temporarily moved under any circumstances.

It has long been customary for elevator installations to equip static inverters with switches, relays or contactors in order to be able to safely and reliably disconnect the power supply from the drive machine 9.

Such switches, relays or contactors are now to be replaced by the use of electronic circuits. Such electronic circuits can be advantageous in terms of lower cost, lower noise and/or higher reliability than conventional switches, relays or contactors.

For this purpose, a safety torque off device 15 is connected between the signal generator device 17 and the power supply device 13, with the aid of which torque generation of the drive machine 9 supplied by the power supply device 13 can be reliably interrupted. The signal generator device 17 and the safety torque off device 15 are jointly part of an inverter control 19.

Official regulations such as the European standards EN61800-5-2:2007 and EN81-20:2014 or their previous version EN81.1:1998 specify specifications and requirements that must be taken into account when building or operating elevator installations.

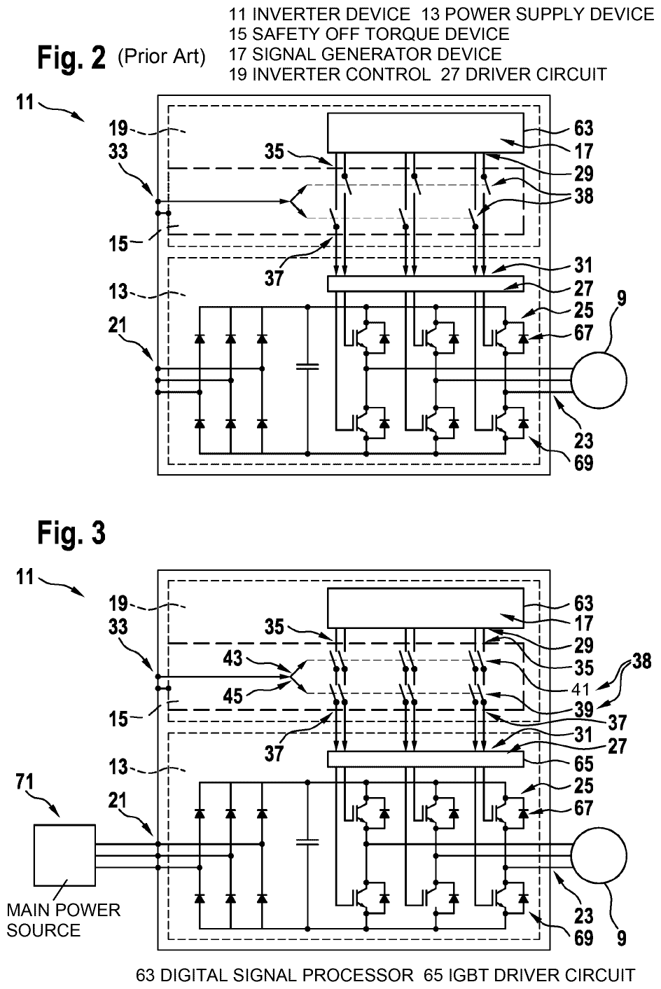

In addition to these specifications and requirements, the following additional specifications can be defined, which can have a substantial influence on the design of a circuit for a safety torque off device:
i) In order to avoid software becoming part of a certification of elevator components, it may be preferable to implement the safety torque off device without using any programmable logic components. This measure can reduce expenditure for maintenance or the like.
ii) The safety torque off device should be able to be used for or in inverter devices from different manufacturers and thus with different construction concepts. This requirement can have a significant impact on the safety function. Earlier concepts of safety torque off devices could be designed in the manner shown in FIG. 2. They consisted of a 2-channel structure, each of which could either interrupt the PWM signals to the three upper IGBTs or the three lower IGBTs of a power supply device. Failure in one of the channels resulted in either the top or bottom IGBTs not being interrupted. It was believed that turning off all of the top IGBTs or all of the bottom IGBTs would be sufficient to prevent the inverter from inducing a rotating field in the AC motor of the connected drive machine, which would build up torque and cause the motor to rotate. Therefore, it had to be possible to rule out crosstalk between the PWM signals for the upper side and for the lower side in the IGBT gate driver circuit. However, such a malfunction cannot be reliably ruled out for certain power modules. Therefore, as described further below, the circuit for the safety torque off device was added as shown in FIG. 3. In this way, even in the event of a fault in one of the channels, the power from the drive machine is reliably disconnected, even in the event of a fault in the power unit.
iii) The circuit of the safety torque off device should preferably be implemented in the inverter control or on its circuit board, which can be used unchanged in various inverter variants. Such a procedure can reduce the effort required to certify each variant of inverters.
iv) The circuit of the safety torque off device should be certified according to EN81-20:2014 and EN81-1:1998 in order to be able to use the inverter in regions where the new standard is not accepted.

As a consequence, it may be preferable to implement the switching of the safety torque off device in accordance with EN61800-5-2:2007 with a safety integrity level SIL3 and a hardware fault tolerance of at least 1 as well as in accordance with EN81-1:1998 § 14.1, which increases the necessary hardware fault tolerance to meet the requirements of the fault tree, i.e., for example, to meet a fault tolerance of three components (transistors) in EN81.

Taking into account the specified specifications and requirements, a safety torque off device 15 is therefore proposed for an inverter device 11, as is shown by way of example in FIG. 3. The inverter device 11 differs from the earlier concept shown in FIG. 2 mainly with regard to the structure of the safety torque off device 15.

The inverter device 11 is supplied with electrical power in the form of a three-phase current at a power input 21 by a main power source 71. In the power supply device 13 of the inverter device 11, the electrical power supplied is conducted to power switches 25 in the form of three upper IGBTs 67 and three lower IGBTs 69. Depending on the switching state of the IGBTs 67, 69, the electrical power is then passed on to a power output 23 of the power supply device 13. The elevator installation 1 drive machine 9 is connected to this power output 23.

The IGBTs 67, 69 are controlled by a common driver circuit 27 in the form of an IGBT driver circuit 65. The IGBT driver circuit 65 controls each of the three upper and three lower IGBTs 67, 69 in response to PWM signals which were generated by the signal generator device 17 in the inverter control 19.

In order to be able to interrupt the forwarding of the PWM signals from the signal generator device 17 to the driver circuit 27 if necessary, the safety torque off device 15 is connected between the signal generator device 17 and the driver circuit 27. Each of six signal outputs 29 of the signal generator device 17 is connected to a signal input terminal 35 of the safety torque off device 15. Furthermore, each of six signal inputs 31 of the driver circuit 27 is connected to a signal output terminal 37 of the safety torque off device 15.

In contrast to the earlier concept shown in FIG. 2, in which only a single signal transmission switch 38 was provided between each of the signal input terminals 35 and the assigned signal output terminal 37 in the safety torque off device 15, the concept presented here provides, between each of the signal input terminals 35, two signal transmission switches 39, 41 connected in series with the associated signal output terminal 37. By switching both the first signal transmission switch 39 and the second signal transmission switch 41 to a conducting state, an electrically conducting connection can be established between the respective signal input terminal 35 and the associated signal output terminal 37.

In order to be able to switch the switching states of the first and second signal transmission switches 39, 41 independently of one another, a first control unit 43 and a second control unit 45 independent of this are provided in the safety torque off device 15 (shown only very schematically in FIG. 3). Both control units 43, 45 are electrically connected to a control input 33 of the safety torque off device 15 and can receive via this control input 33, for example, a control signal to be used to control a temporary interruption of the torque generation of the drive machine. For example, such a control signal can be supplied by a safety chain of the elevator installation 1. The first control unit 43 switches the switching states of all the first signal transmission switches 39, whereas the second control unit 45 controls the switching states of all the second signal transmission switches 41.

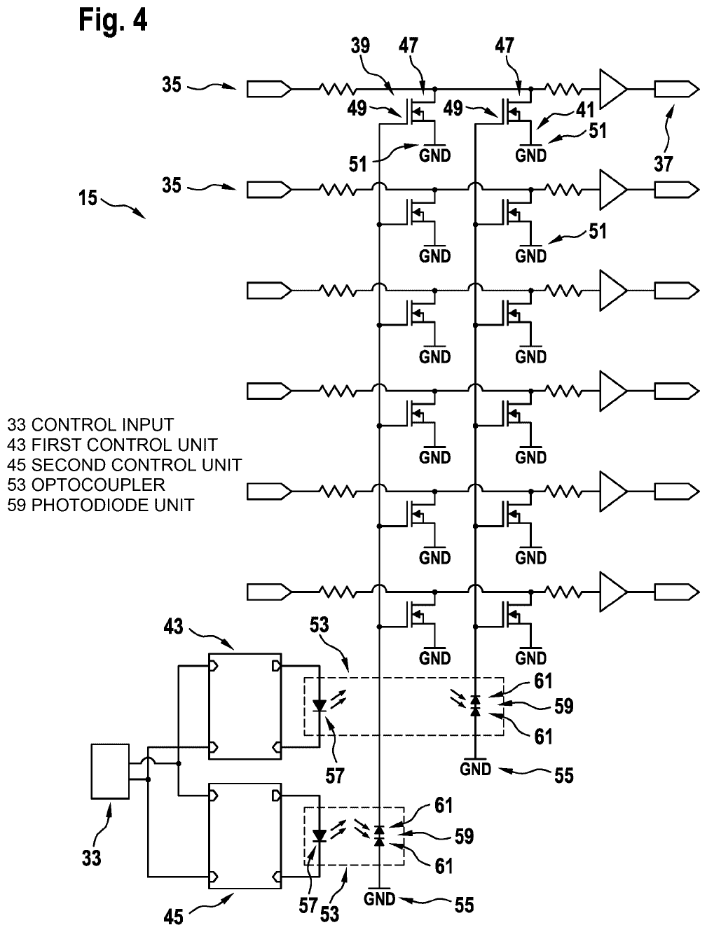

### In Fig. 4, a Possible Embodiment of a Circuit for a Safety Torque off Device 15 is shown.

The control input 33 is electrically connected both to the first control unit 43 and to the second control unit 45. Each of the two control units 43, 45 has its own optocoupler 53. A light source 57, for example in the form of an LED, is provided in the respective optocoupler 53. Depending on the control signal applied to the control input 33, the light source 57 is excited to emit light or not. The optocoupler 53 also has a photodiode unit 59. The photodiode unit 59 is galvanically decoupled from the rest of the optocoupler 53 and in particular from the control input 33. Each photodiode unit 59 comprises two photodiodes 61 which are connected to one another in series. When light strikes the photodiodes 61, they generate an electrical voltage similar to a solar cell.

Each photodiode unit 59 is connected on one side to a ground potential 55 and on an opposite side to gate terminals 49 of a plurality of semiconductor switches 47. In the example shown, the photodiode unit 59 of the optocoupler 53 of the first control unit 43 is connected to the gate terminals 49 of semiconductor switches 47, which serve as second signal transmission switches 41, whereas the photodiode unit 59 of the optocoupler 53 of the second control unit 45 is connected to the gate terminals 49 of semiconductor switches 47 serving as first signal transmission switches 39.

The semiconductor switches 47 are designed as switches that are electrically conductive in the normal state and are connected in such a way that, in the absence of a control voltage at the respective gate terminal 49, they establish an electrical connection between one of the signal input terminals 35, to which a drain terminal or a source terminal of the semiconductor switch 47 is connected, and a ground potential 51. In this case, any electrical voltage signal that may be present at the respective signal input terminal 35 is diverted via the semiconductor switch 47 to the ground potential 51 and thus cannot be passed on to the signal output terminal 37 electrically connected to the signal input terminal 35. A transmission of signals from the signal generator device 17 that are present at the signal input terminals 35 is thus reliably interrupted in the absence of a control voltage at the gate terminals 49.

Only when a control signal is present at the control input 33 of the safety torque off device 15, which causes the light sources 57 of the two optocouplers 53 to send light to the respective photodiode unit 59 and the photodiodes 61 then jointly generate a sufficiently high control voltage at the gate terminals 49 of all of the semiconductor switches 47 to them, can the semiconductor switches 47 switch to a non-conductive state. This interrupts the electrical connection between the signal input terminals 35 and the ground potential 51, so that the signals from the signal generator device 17 are passed on to the respective signal output terminals 37. In response to the receipt of these signals, the driver circuit 27 connected to it can then activate the power supply device 13 to pass a desired electrical power through to the drive machine 9.

In summary and in other words, the circuit for the safety torque off device 15 can be implemented with the topology shown in FIG. 4. The input of the safety chain is used to control the LEDs of two optocouplers 53. The photovoltaic outputs of the optocouplers, which are designed with a plurality of photodiodes connected in series, are used to activate the gates of normally conducting semiconductor components. As long as no voltage is applied to their gates, for example due to switched off LEDs in the optocoupler or a malfunction in an optocoupler, the six PWM signals generated by the DSP 63 in FIG. 3 are short-circuited to the ground potential GND and are therefore prevented from passing through to the power unit. As soon as the LEDs of the optocouplers are activated, a negative voltage is applied to the gate terminals of the semiconductor switches, which causes them to become high-impedance. As a result, the six PWM signals are passed unchanged through the circuit of the safety torque off device.

The topology used for the safety circuit of the safety torque off device can enable the following significant advantages:
The electrical or electronic system of the safety torque off device can be placed in the inverter control or on the inverter control board. It can therefore be used for different versions of static inverters without the need for further certification of the safety function.
Since there are no requirements for the power supply device or the power board, this is not part of the certification.
The forwarding of the signals present at the signal input terminals of the safety torque off device to the ground potential is better suited for different topologies of power supply devices. This reduces the need to add additional driver circuits afterwards.
Since the safety circuit is built on an error-proof principle, there are no error states that can be detected. It is therefore no longer a requirement to open the safety circuit after each trip, which can simplify the construction of the elevator control.
The safety circuit is only supplied with power by the safety circuit itself and does not require any additional supply.
The safety chain no longer needs to feed large coils of switches, relays or contactors, so that its own power supply including a copper wire diameter in the conducting cables can be reduced.

In summary, the proposed safety torque off device can consist of a cost-efficient and robust electrical or electronic system that meets all requirements. A higher effort compared to previously used solutions can provide substantial advantages in terms of maintenance. In addition, there are no requirements for the connected power supply device and the safety circuit.

Finally, it should be noted that terms such as “comprising,” “having,” etc. do not preclude other elements or steps and terms such as “a” or “an” do not preclude a plurality. Furthermore, it should be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A safety torque off device for interrupting a generation of torque by an elevator installation drive machine supplied by a power supply device, wherein the power supply device includes a power input, a power output, a plurality of power switches connected to the power input and to the power output, and a driver circuit controlling the power switches, wherein the power supply device operates such that an electrical power applied to the power input is at least partially passed on to the power output under control of the driver circuit and the power switches as a function of signals applied by a signal generator device from a plurality of first signal outputs to a plurality of first signal inputs of the driver circuit, the safety torque off device comprising:
a control input, a plurality of second signal inputs and a plurality of second signal outputs, wherein each of the first signal outputs of the signal generator device is connected to an associated one of the second signal inputs and each the first signal inputs of the driver circuit is connected to an associated one of the second signal outputs;
wherein the control input is electrically connected to a first control unit and a second control unit, the first control unit being controlled by a control signal applied to the control input to switch first signal transmission switches between the conductive switching state and a non-conductive switching state, and the second control unit being controlled by the control signal applied to the control input to switch second signal transmission switches between the conductive switching state and the non-conductive switching state; and
wherein each of the first and second signal transmission switches is a normally conductive semiconductor switch that, in an absence of a control voltage at a gate terminal thereof, establishes an electrical connection between an associated one of the second signal inputs and a ground potential and, when the control voltage is applied to the gate terminal, interrupts the electrical connection between the associated second signal input and the ground potential, and wherein the first and second control units apply the control voltage to the gate terminals of the first and second signal transmission switches respectively as a function of the control signal applied to the control input.

2. The safety torque off device according to claim 1 including six of the second signal inputs and six of the second signal outputs.

3. The safety torque off device according to claim 1 wherein each of the first and second control units includes an optocoupler adapted, as a function of the control signal applied to the control input, to establish the control voltage at the gate terminals of the first and second signal transmission switches.

4. The safety torque off device according to claim 3 wherein each of the optocouplers includes a light source activated by the control signal applied to the control input and a photodiode unit generating the control voltage in response to illumination by the light source.

5. The safety torque off device according to claim 4 wherein the photodiode units each have two photodiodes connected in series.

6. The safety torque off device according to claim 1 in accordance with a safety integrity level SIL3 and a hardware fault tolerance of at least 1.

7. The safety torque off device according to claim 1 excluding any programmable components.

8. An inverter device for providing electrical drive power for an elevator installation drive machine, the inverter device comprising:
a signal generator device generating control signals at a plurality of first signal outputs;
a power supply device having a power input, a power output, a plurality of power switches connected to the power input and to the power output, and a driver circuit controlling the power switches, wherein the power supply device passes an electrical power applied to the power input at least partially to the power output under control of the power switches and the driver circuit as a function of the control signals generated by a signal generator device from the first signal outputs to first signal inputs of the driver circuit; and
a safety torque off device according to claim 1 wherein each of the first signal outputs of the signal generator device is connected to one of the second signal inputs of the safety torque off device and each of the first signal inputs of the driver circuit is connected to one of the second signal outputs of the safety torque off device.

9. The inverter device according to claim 8 wherein the signal generator device is a digital signal processor.

10. The inverter device according to claim 8 wherein the power supply device includes an IGBT driver circuit, three upper IGBTs and three lower IGBTs, wherein the upper and lower IGBTs are activated by the IGBT driver circuit as a function of the control signals generated by the signal generator device, the control signals being passed through the safety torque off device, to pass on electrical power present at the power input at least partially to the power output.

11. An elevator installation comprising:
an inverter device according to claim 8;
a main power source providing electrical power at the power input of the power supply device of the inverter device; and
an electric drive machine connected to the power output of the power supply device.
